(19) United States
(12) Patent Application Publication
(10) Pub. No.: US 2006/0110035 A1
(43) Pub. Date: May 25, 2006

(54) Method for classifying radiographs

(76) Inventors: Hui Luo, Rochester, NY (US); Jiebo Luo, Pittsford, NY (US); Xiaohui Wang, Pittsford, NY (US)

Correspondence Address: Pamela R. Crocker;Patent Legal Staff, Eastman Kodak Company, 343 State Street, Rochester, NY, 14650-2201, US

(21) Appl. No.: 11/285,560

(22) Filed: Nov. 21, 2005

Related U.S. Application Data
(60) Provisional application No. 60/630,326, filed on Nov. 23, 2004.

(51) Int. Cl. G06K 9/00; G06K 9/34

(52) U.S. Cl. 382/170; 382/132; 382/173

(57) ABSTRACT

A method for classifying radiographs. The method includes the steps of: accessing a radiograph; categorizing the radiograph into pre-determined classes based on gross characteristics of the radiograph, and recognizing the image contents in the radiograph.

### CROSS REFERENCE TO RELATED APPLICATIONS

Reference is made to, and priority is claimed from, U.S. Provisional Application No. 60/630,326, entitled “METHOD FOR CLASSIFYING RADIOGRAPHS”, filed on Nov. 23, 2004 in the names of Luo et al, and which is assigned to the assignee of this application, and incorporated herein by reference.

### FIELD OF THE INVENTION

The present invention relates generally to techniques for processing radiographs, and more particularly to techniques for automatically classifying radiographs.

### BACKGROUND OF THE INVENTION

Accurate medical diagnosis often depends on the correct display of diagnostically relevant regions in images. With the recent advance of computed radiographic systems and digital radiographic systems, the acquisition of an image and its final ‘look’ are separated. This provides flexibility to users, but also introduces a difficulty in setting an appropriate tone scale for image display.

An optimal tone scale, generally, is dependent upon the examination type, the exposure conditions, the image acquisition device and the choice of output devices, as well as the preferences of the radiologist. Among them, the examination type is viewed one determinant factor, since it is directly related to the characteristics of clinical important parts in images. Therefore, the success of classifying examination types can benefit the optimal rendition of images.

An emerging field of using the examination type classification is digital Picture Archiving and Communication Systems (PACS). To date, most radiograph related information is primarily based on manual input. This step is often skipped or the incorrect information is recorded in the image header, which can hinder the efficient use of images in routine medical practice and patient care.

Thus, an automated image classification has potential to solve the above problem by organizing and retrieving images based on image contents. This can make the medical image management system more rational and efficient, and undoubtedly improve the performance of PACS.

However, classifying radiographs is a challenging problem as radiographs are often taken under a variety of examination condition. The patient's pose and size could be variant; so too is the preference of the radiologist depending on the patient's situation. These factors can cause radiographs from the same examination to appear quite different. Human beings tend to use high level semantics to identify a radiograph by capturing the image contents, grouping them into meaningful objects and matching them with contextual information (i.e. a medical exam). However these analysis procedures are difficult for computer to achieve in a similar fashion due to the limitation of the image analysis algorithms.

Attempts have been made toward classifying medical images. For instance, I. Kawshita et. al. (“Development of Computerized Method for Automated Classification of Body Parts in Digital Radiographs”, RSNA 2002) presents a method to classify six body parts. The method examines the similarity of a given image to a set of pre-determined template images by using the cross-correlation values as the similarity measure. However, the manual generation of these template images is quite time consuming, and more particularly, it is highly observer dependent, which may introduce error into the classification.

Guld et. al. (“Comparison of Global Features for Categorization of Medical Images”, SPIE medical Imaging 2004) discloses a method to evaluate a set of global features extracted from images for classification.

In both methods, no preprocessing is implemented to reduce the influence of irrelevant and often distracting data. For example, the unexposed regions caused by the x-ray collimators during the exposure may result in a significant white borders surrounding the image. If such regions are not removed in a pre-processing step and therefore used in the computation of similarity measures, the classification results can be seriously biased.

Recent literature focuses on natural scene image classification. Examples include QBIC (W. Niblack, et al, “The QBIC project: Querying images by content using color, texture, and shape” Proc. SPIE Storage and Retrieval for Image and Video Databases, February 1994), Photobook (A. Pentland, et. al. “Photobook: Content-based manipulation of image database”. International Journal of Computer Vision, 1996), Virage (J. R. Bach, et al. “The Virage image search engine: An open framework for image management” Proc. SPIE Storage and Retrieval for image and Video Database, vol 2670, pp. 76-97, 1996), Visualseek (R. Smith, et al. “Visualseek: A fully automated content-based image query system” Proc ACM Multimedia 96, 1996), Netra (Ma, et al. “Netra: A toolbox for navigating large image databases” Proc IEEE Int. Conf. On Image Proc. 1997), and MAR (T. S. Huang, et. al, “Multimedia analysis and retrieval system (MARS) project” Proc of 33^{rd} Annual Clinic on Library Application of Data Processing Digital Image Access and Retrieval, 1996). These systems follow the same computational paradigm which treats an image as a whole entity and represents it via a set of low-level features or attributes, such as color, texture, shape and layout. Typically, all these feature attributes together form a feature vector and image classification is based on clustering these low-level visual feature vectors. In most cases, the most effective feature is color. However, the color information is not available in radiographs. Therefore these methods are not directly suitable for radiograph projection view recognition.

To overcome the problems of the prior art, there exists a need for a method to classify radiographs and automatically recognize the projection view of radiographs. Such a method be robust so as to handle large variations in radiographs.

### SUMMARY OF THE INVENTION

An object of the present invention is to provide an automated method for classifying radiographs.

Another object of the present invention is to provide a method for recognizing the image contents of radiographs.

Yet another object of the present invention is to provide a method for automatically recognizing the projection view of radiographs.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to the present invention, these objectives are achieved by the following steps: accessing the input radiograph; categorizing the input radiograph; and recognizing the image contents in the radiograph. Categorizing the radiograph comprises of segmenting the radiograph into foreground, background and anatomy regions, classifying the physical size and the gross shape of the radiograph, and combining the classification results to categorize the radiograph accordingly. Recognizing the image contents in the radiograph is accomplished by performing shape recognition and appearance recognition, and identifying the image contents based on the recognition results.

According to one aspect of the invention, there is provided a method for classifying of exam type of a radiograph with respect to body part and projection view. The method includes the steps of: acquiring a radiographic image; categorizing the radiographic image into pre-determined classes based on gross characteristics; and recognizing the exam type of the radiographic image.

The present invention provides some advantages. Features of the method promote robustness. For example, preprocessing of radiographs helps avoid the interference from the collimation areas and other noise. In addition, features used for orientation classification are invariant to size, translation and rotation. Features of the method also promote efficiency. For example, all processes can be implemented on a sub-sampled coarse resolution image, which greatly speeds up the recognition process.

### BRIEF DESCRIPTION OF THE DRAWINGS

The foregoing and other objects, features, and advantages of the invention will be apparent from the following more particular description of embodiments of the invention, as illustrated in the accompanying drawings. The elements of the drawings are not necessarily to scale relative to each other.

FIG. 1 shows a flow chart illustrating the automated method for classifying radiographs in accordance with the present invention.

FIG. 2 shows a flow chart illustrating the steps performed for categorizing the radiographs in accordance with the present invention.

FIGS. 3A-3E show a diagrammatic view showing the results from the preprocessing step. FIG. 3A shows the original image. FIGS. 3B-3D depict its foreground, background and anatomy images from the segmentation, respectively. FIG. 3E shows a normalized image.

FIGS. 4A-4C show diagrammatic views illustrating the classification of the shape pattern of radiograph edge direction histogram. FIG. 4A shows the original image. FIG. 4B shows the anatomy image after segmentation. FIG. 4C shows the edge direction histogram of the anatomy image.

FIG. 5 shows a flow chart illustrating the steps performed for recognizing the radiographs in accordance with the present invention.

FIGS. 6A-6B show diagrammatic views illustrating the extraction of region of interest in the radiograph in accordance with the present invention. FIG. 6A shows the original image. FIG. 6B shows the region of interest extracted in the radiograph.

### DETAILED DESCRIPTION OF THE INVENTION

The following is a detailed description of the preferred embodiments of the invention, reference being made to the drawings in which the same reference numerals identify the same elements of structure in each of the several figures.

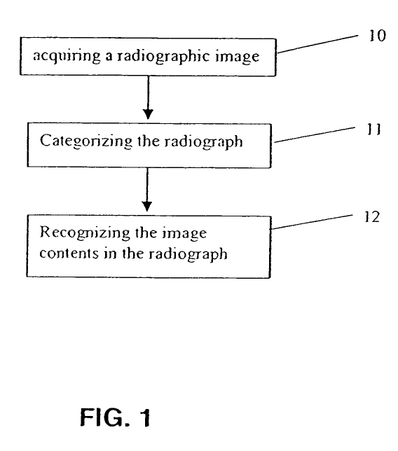

The present invention is directed to a method for automatically classifying radiographs. A flow chart of a method in accordance with the present invention is generally shown in FIG. 1. As shown in FIG. 1, the method includes the steps of: acquiring/accessing a digital radiograph (step 10), categorizing the radiograph (step 11), and recognizing the image contents in the radiograph (step 12).

According to the present invention, the image contents refer to the exam type information in the radiograph, for example, the body part and projection view information in the radiograph.

For ease of explanation, the invention will be described using a foot radiograph. It is noted that the present invention is not limited to such an image content but can be employed with any image content.

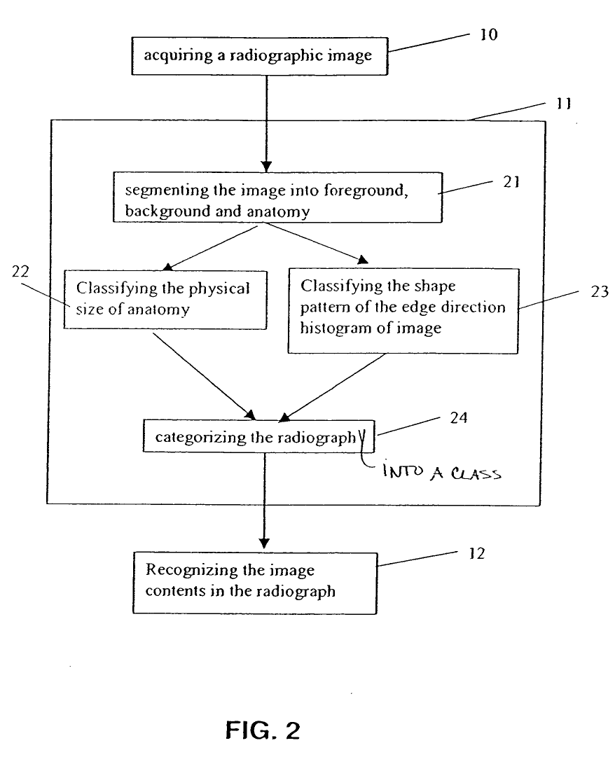

Referring now to FIG. 2, there is shown a flow chart more particularly illustrating the method of the present invention, and particularly, the step of categorizing the radiograph (step 11).

The step of categorizing the radiograph is employed to reduce the computation complexity of the method and minimize the match operations needed in the recognition stage. There are known methods able to conduct such categorization. One suitable technique is disclosed in U.S. Provisional Application No. 60/630,286, entitled “AUTOMATED RADIOGRAPH CLASSIFICATION USING ANATOMY INFORMATION”, filed on Nov. 23, 2004 in the names of Luo et al, and which is assigned to the assignee of this application, and incorporated herein by reference.

To conduct the categorization, the method starts with segmenting the radiograph into three regions (step 21): a collimation region (i.e., foreground), a direct exposure region (i.e., background) and a diagnostically relevant region (i.e., anatomy). Then, two classifications can be performed on the image: one classification is based on a physical size of the anatomy (step 22), and the other classification focuses on a gross shape of the anatomy region (step 23). Afterwhich, the results from both classifications are combined, and the acquired/input radiograph is categorized into one or more (for example, eight) pre-defined classes (step 24).

Image segmentation (step 21) can be accomplished using methods known to those skilled in the art. One suitable segmentation method is disclosed in U.S. Ser. No. 10/625,919 filed on Jul. 24, 2003 by Wang et al., entitled METHOD OF SEGMENTING A RADIOGRAPHIC IMAGE INTO DIAGNOSTICALLY RELEVANT AND DIAGNOSTICALLY IRRELEVANT REGIONS, commonly assigned and incorporated herein by reference.

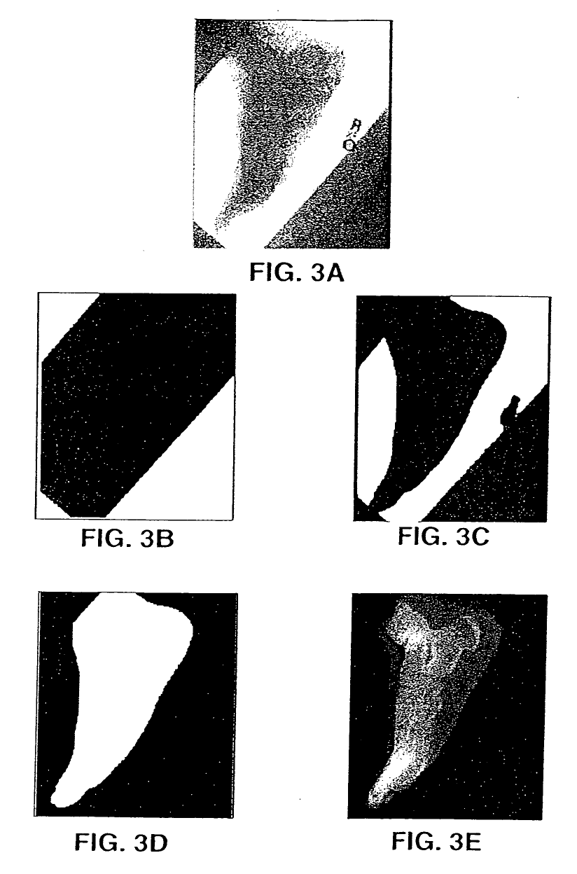

FIG. 3A shows an exemplary foot radiograph and FIGS. 3B-3D show its foreground, background and anatomy images, respectively, obtained from segmentation.

Once the image is segmented, the foreground and background regions are removed from the image. The remaining anatomy region can then be normalized to compensate for difference in exposure densities caused by patient variations and examination conditions. FIG. 3E displays the resulting image after intensity normalization.

To perform the physical size classification of the radiograph (step 22), six features are extracted from the foreground, background and anatomy images. These features are then fed into a pre-trained classifier, such as described in commonly assigned application U.S. Ser. No. 10/993,055, entitled “DETECTION AND CORRECTION METHOD FOR RADIOGRAPH ORIENTATION”, filed on Nov. 19, 2004 in the names of Luo et al, and incorporated herein by reference. The output of the classifier will identify whether the anatomy in the radiograph belongs to a large size anatomy group or a small size anatomy group. For instance, the foot radiograph in FIG. 3A can be classified as a small size anatomy.

The success of the gross shape classification (step 23) is dependant on its capability to handle large variations in radiographs. Such variations include size, orientation and translation difference of anatomy in radiographs. In a preferred embodiment of the present invention, a gross shape classification is adopted.

A suitable gross shape classification is described in U.S. Provisional Application No. 60/630,286, entitled “AUTOMATED RADIOGRAPH CLASSIFICATION USING ANATOMY INFORMATION”, filed on Nov. 23, 2004 in the names of Luo et al, and which is assigned to the assignee of this application, and incorporated herein by reference.

Such a gross shape classification can be performed by three steps: the edge of anatomy is extracted; the edge direction histogram is then computed; and a scale, rotation and translation invariant shape classifier is used to classify the edge direction histogram into pre-defined shape patterns (preferably, into one of four pre-defined shape patterns).

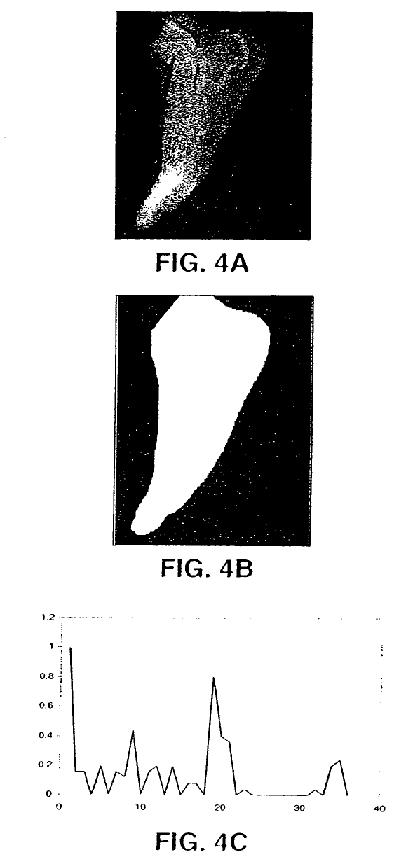

FIGS. 4A-4C illustrates an implementation of gross shape classification for the image of a foot. FIG. 4A shows the original image and FIG. 4B shows the anatomy image after segmentation. FIG. 4C shows the edge direction histogram of the anatomy image. As shown in FIG. 4C, the foot has edge directions ranging from 0 to 360 degree, therefore its edge direction distribution spreads out nearly all degrees in the histogram. As a result, the foot radiograph is classified as the other shape pattern edge direction histogram.

Having completed the physical size (step 22) and/or gross shape (step 23) classification, the input radiograph is then categorized (step 24) into one or more classes, preferably into one or more of eight classes. In the preferred arrangement, these classes are derived from the two physical size group and four gross shape patterns. The feature of having more than one resulting classes assigned to a radiograph is to keep the ambiguity of the radiograph, and such ambiguity is expected to be reduced in the recognition stage.

According to the present invention, each of eight classes comprises several exam types, each sharing a similar physical size and gross shape pattern. For example, the small-size anatomy with the other shape pattern edge direction histogram, which the foot radiograph is categorized, includes seven possible exam types. They are: hand Anterior-Posterior (AP) view, hand lateral view, hand oblique view, skull AP view, skull lateral view, skull oblique view, and foot lateral view. To further classify the foot radiograph and separate it from the rest of exam types, a more detail content recognition is needed.

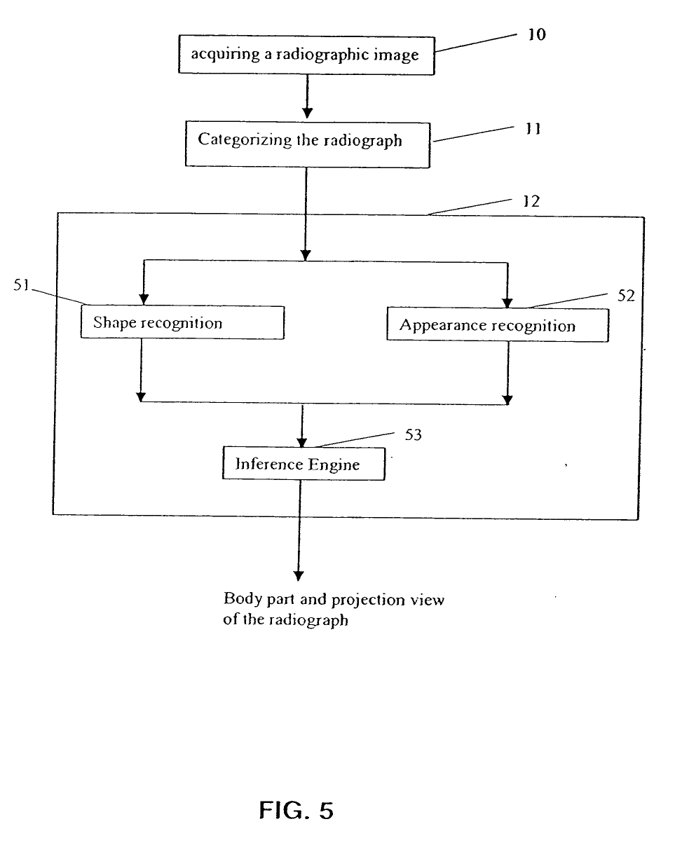

Reference is now made to FIG. 5 which shows a flow chart illustrating the step of recognizing the radiograph (step 12).

This step is employed to recognize the body part and projection view of the radiograph. There are numerous features in the radiograph that can be used for recognition, such as the shape contour of anatomy and the appearance of the image. To accomplish this step, the present invention takes advantage of useful information in the radiograph, and performs recognition on each feature (step 51 and step 52). Then, the recognition results are combined to identify the body part and projection view of the radiograph (step 53).

With regard to step 51, shape recognition is implemented on the radiograph. An advantage of shape recognition is that it can provide a way to recognize the anatomical structures with significant shape features, such as hand, skull and foot. It is noted that this step differs from the gross shape classification step (step 23) described with reference to step 11. In step 51, because the shape recognition here focuses on the substantially exact shape match, its result is intended to directly specify whether the shape is similar or not to a target shape. In contrast, the gross shape classification (step 23) groups the exam types with similar edge direction histogram, no matter the significant difference between their shapes.

A suitable shape classification method is disclosed in U.S. Provisional Application No. 60/630,270, entitled “METHOD FOR AUTOMATIC SHAPE CLASSIFICATION”, filed on Nov. 23, 2004 in the name of Luo, and which is assigned to the assignee of this application, and incorporated herein by reference.

Still using the example of the foot radiograph, the method constructs a training database for the foot radiograph. The database contains the foot lateral view shapes learned from radiographs and also some other shapes. Then, an average shape is computed from all foot shapes in the database, and a distance is later calculated after aligning each shape in the database, including both the foot shapes and all other shapes, to the average shape. By putting the distances together, the method generates a distance distribution, in which the foot lateral shapes tend to have small distances while other shapes present a large distance variation due to the significant distinctions from the average shape. In order to best separate the foot shape from the other shapes, a threshold is derived from the distribution. At the last step of shape recognition, the method classifies the shape with the distance smaller than the threshold as the foot lateral radiographs.

With regard to step 52, an appearance-based image recognition is used to recognize the radiograph. Such recognition focuses on the appearance of the radiograph. That is, it identifies the similarity of the image based on the intensity and spatial information. Suitable methods known to those skilled in the art to accomplish this step. One suitable method is disclosed in U.S. Provisional Application No. 60/630,287, entitled “METHOD FOR RECOGNIZING PROJECTION VIEWS OF RADIOGRAPHS”, filed on Nov. 23, 2004 in the names of Luo et al, and which is assigned to the assignee of this application, and incorporated herein by reference. This method includes the steps of: correcting the orientation of the input radiograph, extracting a region of interest (ROI) from the radiograph, and recognizing the radiograph based on the appearance of ROI.

To conduct the orientation correction of the radiograph, a suitable method is disclosed in U.S. Ser. No. 10/993,055, entitled “DETECTION AND CORRECTION METHOD FOR RADIOGRAPH ORIENTATION”, filed on Nov. 19, 2004 in the names of Luo et al, and which is assigned to the assignee of this application, and incorporated herein by reference.

Due to variations in radiographs, directly performing recognition on the radiograph is not preferred since the difference from scale, rotation and translation, as well as the selected portion of anatomy can bias the recognition results.

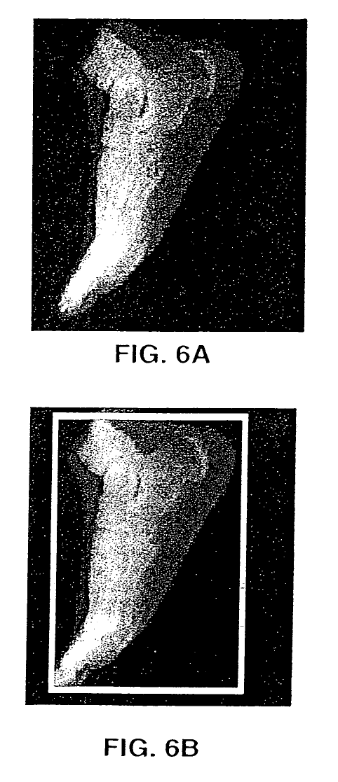

To address this situation, a Region of Interest (ROI) is extracted from the radiograph. This ROI aims to capture a diagnostically useful part from image data, and minimize the variations caused by the above factors. One suitable method to extract such ROI is disclosed in U.S. Provisional Application No. 60/630,287, entitled “METHOD FOR RECOGNIZING PROJECTION VIEWS OF RADIOGRAPHS”, filed on Nov. 23, 2004 in the names of Luo et al, and which is assigned to the assignee of this application, and incorporated herein by reference. As an example, FIGS. 6A and 6B show diagrammatic views illustrating the extraction of region of interest in the foot radiograph. FIG. 6A shows the original image, and FIG. 6B shows the region of interest (ROI) extracted from the foot radiograph.

The recognition of the body part and projection view of image is based on the extracted ROI and accomplished by classifying the radiograph with a set of pre-trained classifiers. Each classifier is trained to classify one body part and projection view from all the others, and its output represents how closely the input radiograph match such body part and projection view.

With the assistance of a set of results from classifiers, an inference engine is employed in a step of recognition (step 53) is to determine the most likely body part and projection view that the input radiograph may have. In a preferred embodiment of the present invention, a probabilistic framework, known as Bayesian decision rule, is used to combine all recognition results and infer the one with highest confidence as the body part and projection view of radiograph.

The present invention may be implemented for example in a computer program product. A computer program product may include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The system of the invention can include a programmable computer having a microprocessor, computer memory, and a computer program stored in said computer memory for performing the steps of the method. The computer has a memory interface operatively connected to the microprocessor. This can be a port, such as a USB port, over a drive that accepts removable memory, or some other device that allows access to camera memory. The system includes a digital camera that has memory that is compatible with the memory interface. A photographic film camera and scanner can be used in place of the digital camera, if desired. A graphical user interface (GUI) and user input unit, such as a mouse and keyboard can be provided as part of the computer.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 Step—Acquiring a radiographic image
11 Step—Categorizing the radiograph
12 Step—Recognizing the image contents of radiograph
21 Step—Segmenting the image into foreground, background and anatomy
22 Step—Classifying the physical size of the anatomy
23 Step—Classifying the shape pattern of the edge direction histogram of image
24 Step—Categorizing the radiograph
51 Step—Shape recognition
52 Step—Appearance recognition
53 Step—Inference engine

What is claimed is:

1. A method for classifying a radiographic image, comprising the steps of:
acquiring a radiographic image;
categorizing the radiographic image into pre-determined classes based on gross characteristics of the radiographic image; and
recognizing the exam type of the radiographic image with respect to body part and projection view.

2. The method of claim 1, wherein the step of categorizing the radiographic image comprises the steps of:
segmenting the radiographic image into foreground, background and anatomy regions;
classifying a physical size of the anatomy region;
generating an edge direction histogram of the anatomy region;
classifying a shape pattern of the edge direction histogram; and
categorizing the radiographic image into the pre-determined classes based on gross characteristics.

3. The method of claim 2, wherein the gross characteristics include a physical size of the anatomy region and the shape pattern of the edge direction histogram.

4. The method of claim 1, wherein the step of recognizing the exam type of the radiograph comprises the steps of:
performing a shape recognition according to a pre-trained shape model;
performing an appearance recognition according to a pre-trained appearance model; and
combining the shape recognition and the appearance recognition using an inference engine.
